(19) United States
(12) Patent Application Publication
(10) Pub. No.: US 2014/0211485 A1
(43) Pub. Date: Jul. 31, 2014

(54) BAY LAMP WITH COOLING PLATE

(71) Applicant: HERGY LIGHTING TECHNOLOGY CORP., Taipei City (TW)

(72) Inventors: Yu-Jen LIN, Taipei City (TW); Chih-Hsin CHEN, Taipei City (TW); Chun-Hung LU, Taipei City (TW)

(73) Assignee: Hergy Lighting Technology Corp., Taipei City (TW)

(21) Appl. No.: 13/754,882

(22) Filed: Jan. 30, 2013

(51) Int. Cl. F21V 29/00

(52) U.S. Cl. CPC F21V 29/004
USPC 362/363; 362/382

(57) ABSTRACT

Disclosed is a bay lamp with a cooling plate. The bay lamp includes a metal lampholder and at least one cooling plate. Each cooling plate includes a vertical plate extended from the metal lampholder, a transverse plate bent and extended from the vertical plate, and a spacing formed between the transverse plate and the metal lampholder. The cooling plate is integrally formed with the metal lampholder and extended from the metal lampholder to substitute a conventional fin, so as to reduce the cost and weight of the bay lamp.

### FIELD OF THE INVENTION

The present invention relates to lighting, and more particularly to a bay lamp with a cooling plate.

### BACKGROUND OF THE INVENTION

In open or spacious places such as playgrounds, malls and factories, lamps are usually installed at positions far away from the ground, so that bay lamps are generally installed to provide a light source with sufficient brightness in the aforementioned places. As the awareness of power saving, carbon reduction, and environmental protection arises, most bay lamps adopt a low power-consuming light emitting diode as a light source. However, the light emitting diode generates lots of heat, and thus it is necessary to install an additional heat dissipating device to the bay lamp in order to achieve the effect of dissipating the heat generated by the light emitting diode.

In general, a conventional bay lamp equipped with a heat dissipating device comprises a lampholder, a plurality of fins installed at a surface on a side of the lampholder and formed and extended perpendicularly from the lampholder, and a light emitting diode installed on the other side of the lampholder, so that the heat generated by the light emitting diode can be dissipated to the outside air through the fins.

However, the conventional bay lamp has the following drawbacks. To dissipate the heat generated by the light emitting diode, it is necessary to install more fins on the lampholder. As a result, the manufacturing process of the lampholder becomes more tedious and complicated, and the manufacturing cost and time of the lamp are increased. In addition, the weight of the assembled lamp is relatively heavier, thus causing tremendous inconvenience to the installation.

In view of the aforementioned problems, the inventor of the present invention based on years of experience in the related industry to conduct extensive researches and experiments to develop and design a bay lamp with a cooling plate to overcome the aforementioned problems of the related art.

### SUMMARY OF THE INVENTION

Therefore, it is a primary objective of the present invention to provide a bay lamp with a cooling plate, and the cooling plate is integrally formed and extended from the metal lampholder, and the cooling plate is provided to substitute the fins of the conventional lamp, so as to reduce the cost and weight of the bay lamp.

To achieve the aforementioned objective, the present invention provides a bay lamp with a cooling plate, and the bay lamp comprises a metal lampholder and at least one cooling plate, and the cooling plate includes a vertical plate extended from the metal lampholder, a transverse plate bent and extended from the vertical plate, and a spacing formed between the transverse plate and the metal lampholder.

The present invention has the following advantages and effects:

1. The cooling plate is formed and extended from the metal lampholder and the cooling plate is also made of metal. The cooling plate includes a vertical plate extended from the metal lampholder and a transverse plate bent and extended from the vertical plate, such that the cooling plate has a large heat dissipating surface areas. Since the cooling plate is made of metal, the large heat dissipating surface area of the cooling plate provides good thermal radiation efficiency, and the bay lamp of the present invention has excellent heat dissipation effect.

2. A spacing is formed between the transverse plate and the metal lampholder to provide an air channel that allows cold outside air to flow through the spacing, so as to enhance the heat dissipation effect of the cooling plate.

3. The transverse plate is extended outwardly towards the exterior of the metal lampholder, and the transverse plate has an inclined section and a horizontal section extended from the inclined section, so that the cooling plate has more space to increase the heat dissipating surface area, so as to enhance the heat dissipation efficiency of the cooling plate.

4. The bay lamp of the present invention further comprises a cover plate and a power supply, and two partitions are extended from the metal lampholder, and an accommodating space is formed between the two partitions. The two partitions are provided for separating the cooling plate from the accommodating space, and the cover plate corresponding to the accommodating space is covered onto the power supply, fixed to the cover plate, and contained in the accommodating space, such that the power supply is maintained at a position away from the heated source such as the metal lampholder and the cooling plate, so as to prevent heat in the heat dissipation process from transmitting to the power supply, and to extend the service life of the power supply.

5. The bay lamp of the present invention further comprises an insulating element installed at the internal periphery of the accommodating space to further isolate the heat of the power supply from the metal lampholder and the cooling plate, so as to extend the service life of the power supply.

6. The bay lamp of the present invention further comprises two panels fixed to the metal lampholder and covered onto two ends of the two partitions respectively, and both ends of the cover plate are fixed to the two panels, such that the cover plate and the panel can be assembled easily to form a housing of the bay lamp effectively, so as to simplify the assembling process of the bay lamp.

7. Each panel has a plurality of vent holes to provide a ventilation function in the accommodating space between the two partitions.

8. The bay lamp of the present invention further comprises a light source module and a transparent cover, and the metal lampholder has a heated surface, and the light source module is fixed to the heated surface, and the metal lampholder has two carrier brackets extended from two sides opposite to the heated surface, and the two carrier brackets jointly have an engagement portion disposed on the corresponding internal side, and both sides of the transparent cover are engaged with the corresponding engagement portion, so that the transparent cover can be covered onto the light source module to simplify the assembling process of the bay lamp.

### BRIEF DESCRIPTION OF THE DRAWINGS

FIG. 1 is an exploded view of a bay lamp of the present invention;

FIG. 2 is a perspective view of a metal lampholder and a cooling plate of the present invention;

FIG. 3 is a cross-sectional view of a metal lampholder and a cooling plate of the present invention;

FIG. 4 is a perspective view of a bay lamp of the present invention;

FIG. 5 is another perspective view of a bay lamp of the present invention; and

FIG. 6 is a schematic view of a using status of a bay lamp of the present invention.

### DESCRIPTION OF THE PREFERRED EMBODIMENTS

The technical contents of the present invention will become apparent with the detailed description of preferred embodiments accompanied with the illustration of related drawings as follows. It is noteworthy that same numerals are used for representing same respective elements respectively in the drawings.

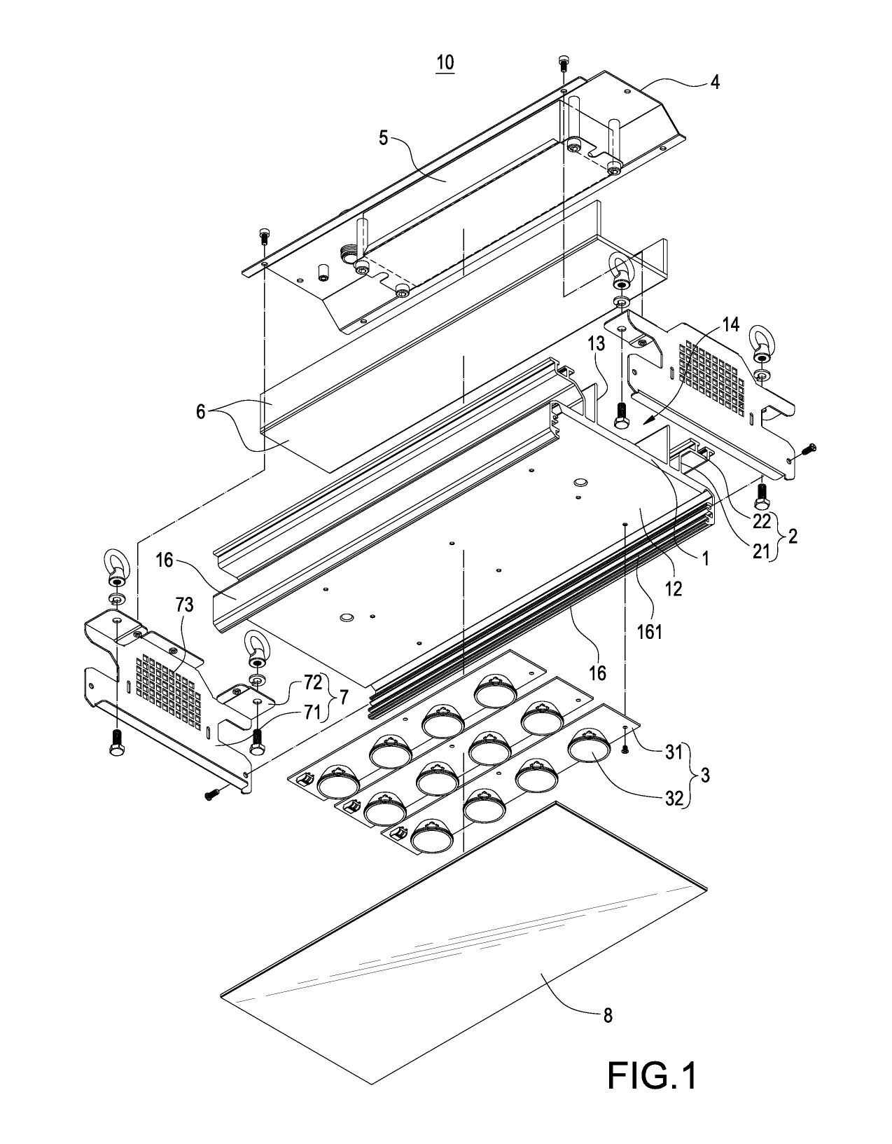

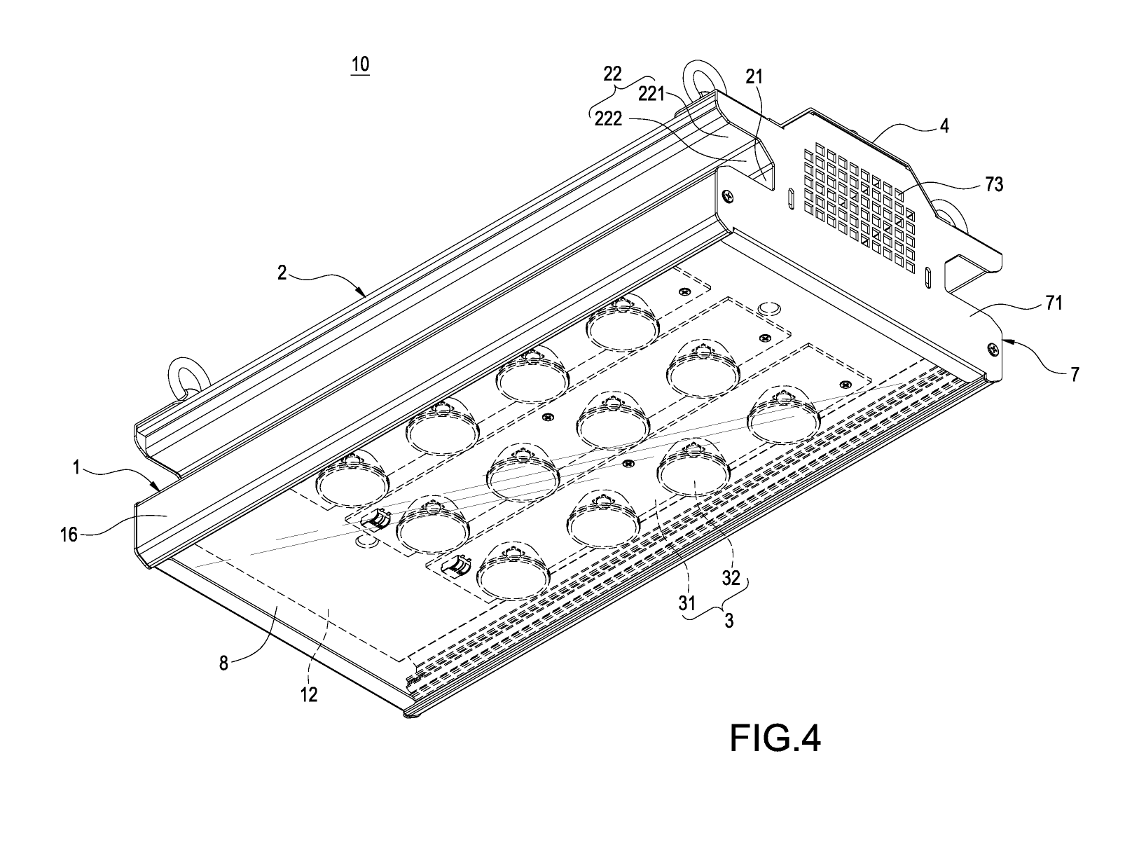

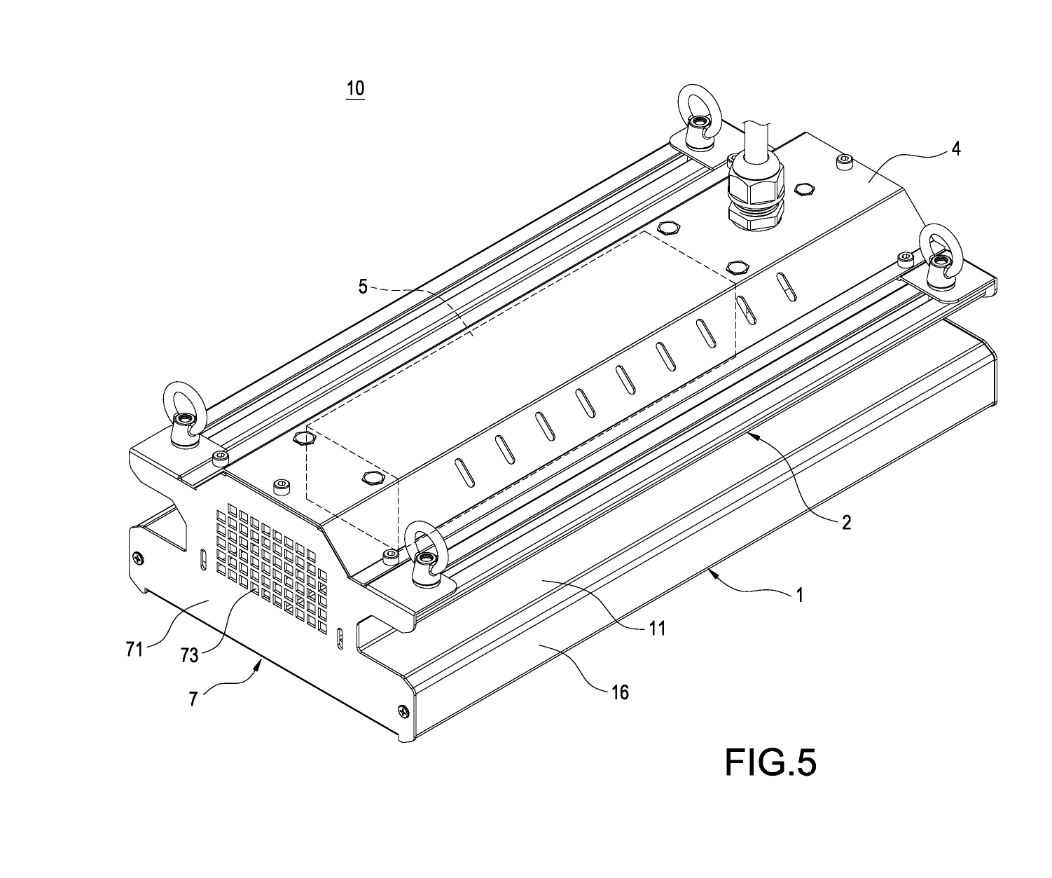

With reference to FIGS. 1 to 5 for a bay lamp with a cooling plate in accordance with the present invention, the bay lamp comprises a metal lampholder 1 and at least one cooling plate 2.

The metal lampholder 1 has a heat dissipating surface 11 formed on one side and a heated surface 12 formed on the other side, two partitions 13 extended from the heat dissipating surface 11 of the metal lampholder 1, and an accommodating space 14 formed between the two partitions 13, wherein the two partitions 13 separate the cooling plate 2 from the accommodating space 14. In addition, the metal lampholder 1 has a bottom surface 15 formed at the bottom of the accommodating space 14, and the metal lampholder 1 has two carrier brackets 16 extended from two sides opposite to the heated surface 12, and the two carrier brackets 16 jointly have an engagement portion 161 disposed at corresponding internal sides.

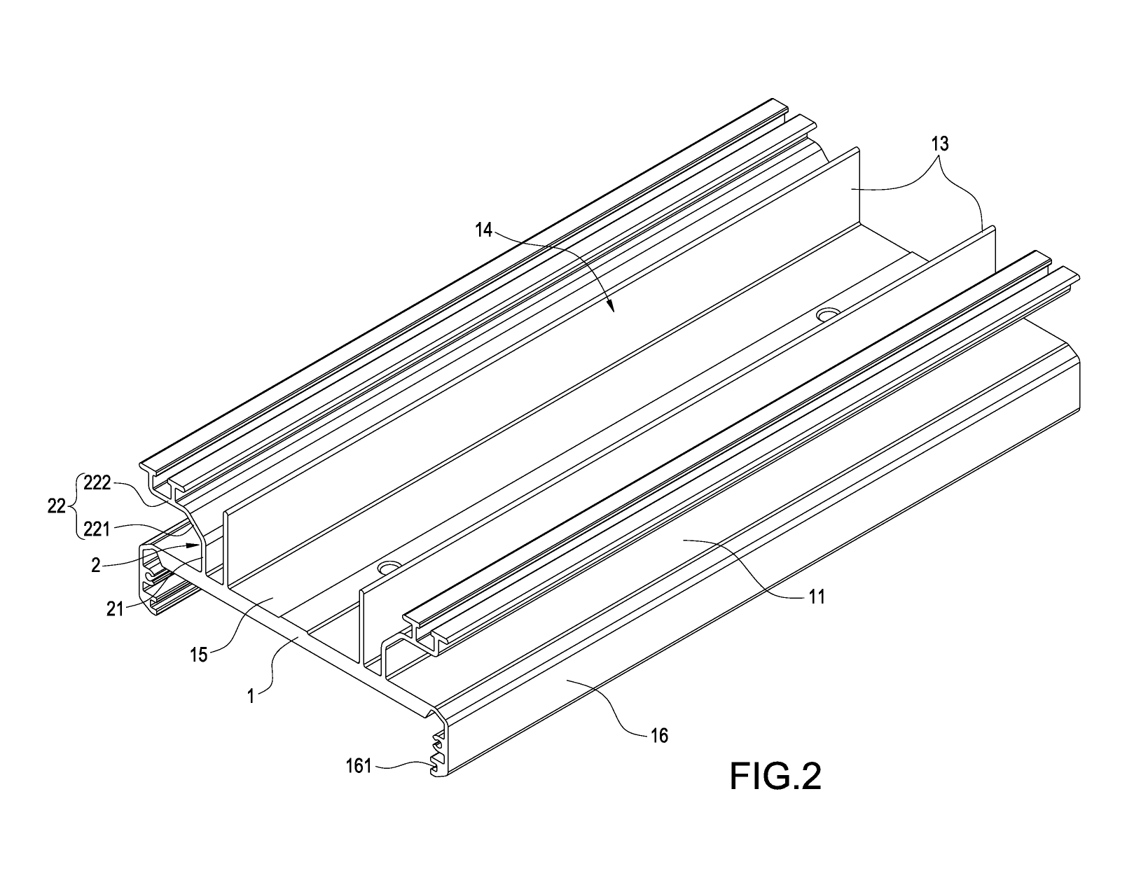

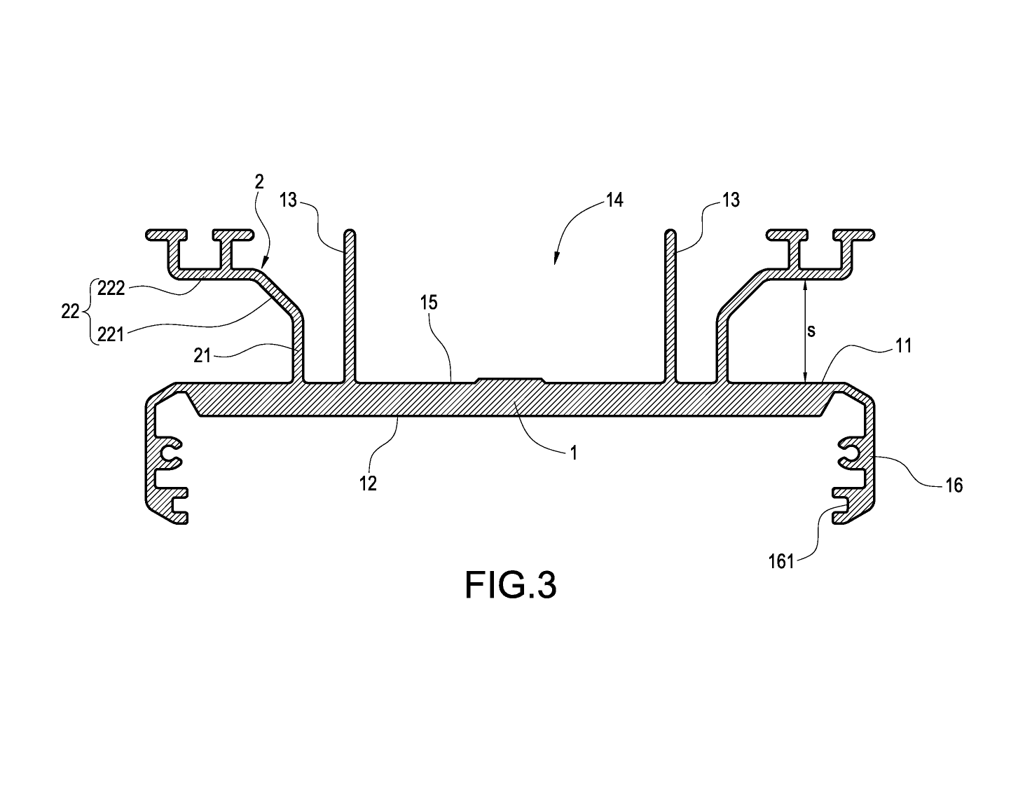

In FIGS. 2 and 3, the cooling plate 2 includes a vertical plate 21 extended from the metal lampholder 1 and a transverse plate 22 bent and extended from the vertical plate 21. The cooling plate 2 is also made of metal, and a spacing “s” is formed between the transverse plate 22 and the metal lampholder 1. In addition, the transverse plate 22 is extended outwardly towards the exterior of the metal lampholder 1, and the vertical plate 21 is perpendicular to the metal lampholder 1. The transverse plate 22 has an inclined section 221 and a horizontal section 222 extended from the inclined section 221, and the inclined section 221 is inclined with respect to the vertical plate 21, and the horizontal section 222 is parallel to the metal lampholder 1. Wherein, two cooling plates 2 are used in this preferred embodiment, but the invention is not limited to such arrangement only. The two cooling plates 2 are formed and extended from the heat dissipating surface 11 and installed on two sides of the two partitions 13 respectively.

The bay lamp 10 of the present invention further comprises a light source module 3 fixed onto the heated surface 12. The light source module 3 includes a circuit board 31 fixed onto the heated surface 12 and a light emitting element 32 installed on the circuit board 31, wherein the light emitting element 32 can be a light emitting diode, an incandescent lamp or a halogen lamp.

The bay lamp 10 of the present invention further comprises a cover plate 4 and a power supply 5, and the cover plate 4 is covered onto the corresponding accommodating space 14, and the power supply 5 is fixed to the cover plate 4 and contained in the accommodating space 14. The power supply 5 has the function of stabilizing current and voltage.

The bay lamp 10 of the present invention further comprises an insulating element 6 which is a thermal paste or a thermal insulation sponge, and the insulating element 6 is installed at the internal periphery of the accommodating space 14. More specifically, the insulating element 6 is fixed onto the bottom surface 15 or onto a side of each partition 13 adjacent to the accommodating space 14.

The bay lamp 10 of the present invention further comprises two panels 7 fixed to the metal lampholder 1 and covered onto two ends of the two partitions 13. Each panel 7 has a main body 71 and a fixed section 72 perpendicularly extended from the main body 71 in a direction towards the partition 13, and both ends of the cover plate 4 are fixed to the two fixed sections 72 respectively. In addition, each main body 71 has a plurality of vent holes 73.

The bay lamp 10 of the present invention further comprises a transparent cover 8, and both sides of the transparent cover 8 are engaged with the corresponding engagement portion 161, so that the transparent cover 8 can be covered onto the light source module 3.

The bay lamp 10 with the cooling plate 2 of the present invention uses the cooling plate 2 including a vertical plate 21 extended from the metal lampholder 1, a transverse plate 22 bent and extended from the vertical plate 21, and a spacing s formed between the transverse plate 22 and the metal lampholder 1. The cooling plate 2 is integrally formed with the metal lampholder 1 and extended from the metal lampholder 1 to substitute the fins used in a conventional lamp, so as to skip the tedious and complicated manufacturing process of the fins and achieve the effect of reducing the manufacturing cost and time of the bay lamp 10. In the meantime, the assembled bay lamp 10 has a smaller volume and a lighter weight than the conventional lamp to facilitate the installation of the bay lamp 10.

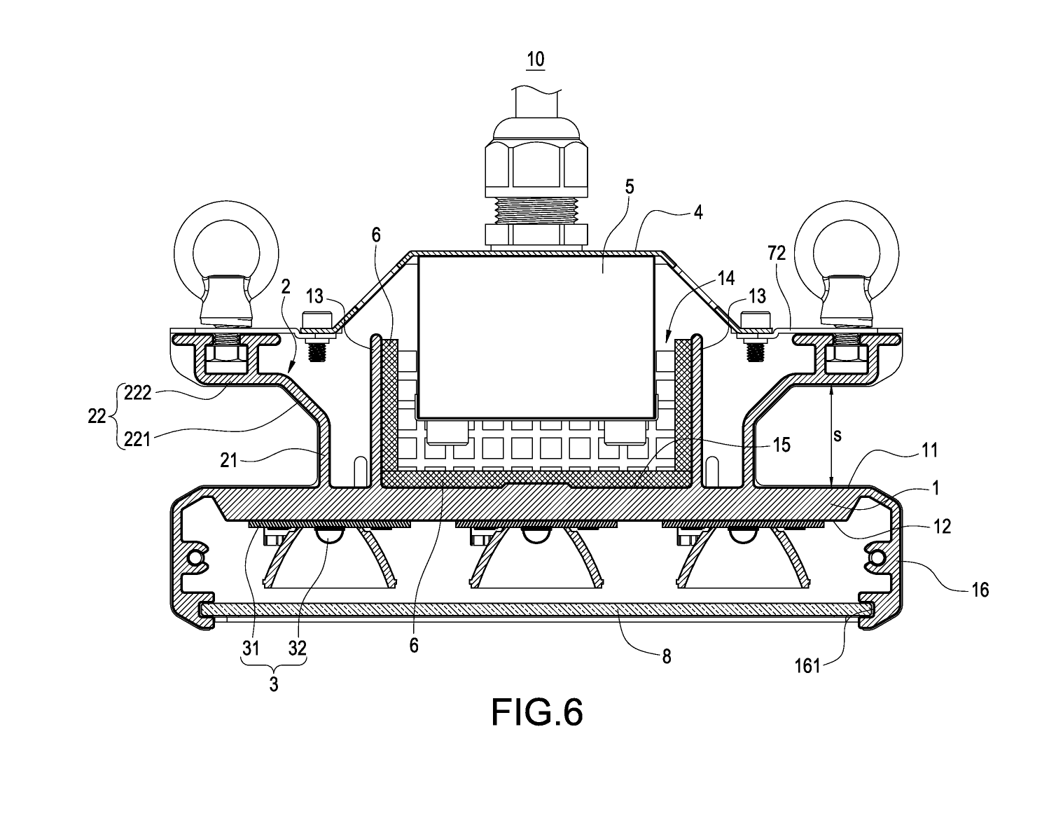

With reference to FIG. 6 for a using status of a bay lamp 10 of the present invention bay lamp 10, the light source module 3 is fixed onto the heated surface 12, and the cooling plate 2 is formed and extended from the heat dissipating surface 11, so that the heat generated by the light source module 3 can be dissipated to the outside air through the cooling plate 2.

The method for the cooling plate 2 to dissipate heat is described below. The cooling plate 2 is formed and extended from the metal lampholder 1 and the cooling plate 2 is also made of metal. In the meantime, the cooling plate 2 includes a vertical plate 21 extended from the metal lampholder 1 and a transverse plate 22 bent and extended from the vertical plate 21, such that the cooling plate 2 has a large heat dissipating surface area. Since the cooling plate 2 is made of metal and has a large heat dissipating surface area, the heat generated by the cooling plate 2 has good thermal radiation efficiency, and the bay lamp 10 of the present invention has excellent heat dissipation effect.

In addition, a spacing “s” is formed between the transverse plate 22 and the metal lampholder 1 to provide an air channel for driving external cold air to flow through the air channel, so as to enhance the heat dissipation effect of the cooling plate 2. Further, the transverse plate 22 is outwardly extended towards the exterior of the metal lampholder 1.

The transverse plate 22 has an inclined section 221 and a horizontal section 222 extended from the inclined section 221, so that the cooling plate 2 has more space to increase the heat dissipating surface area and to enhance the heat dissipation efficiency of the cooling plate 2.

The bay lamp 10 of the present invention further comprises a cover plate 4 and a power supply 5, and two partitions 13 are extended from the metal lampholder 1, and an accommodating space 14 is formed between the two partitions 13. The two partitions 13 are provided for separating the cooling plate 2 from the accommodating space 14, and the cover plate 4 is provided for covering the corresponding accommodating space 14, and the power supply 5 is fixed to the cover plate 4 and contained in the accommodating space 14, such that the power supply 5 can be maintained away from heat sources such as the metal lampholder 1 and the cooling plate 2 to prevent the heat in the heat dissipation process from being transmitted to the power supply 5 and extend the service life of the power supply 5.

The bay lamp 10 of the present invention further comprises an insulating element 6 installed at the internal periphery of the accommodating space 14 to assist the power supply 5 to isolate the heat of the metal lampholder 1 and the cooling plate 2, so as to extend the service life of the power supply 5.

The bay lamp 10 of the present invention further comprises two panels 7 fixed to the metal lampholder 1 and covered onto two ends of the two partitions 13, and both ends of the cover plate 4 are fixed to the two panels 7 respectively, so that the cover plate 4 and the panel 7 can be assembled simply to form the housing of the bay lamp 10 effectively and simplify the assembling process of the bay lamp 10. Further, each panel 7 has a plurality of vent holes 73 to provide a ventilation function to the accommodating space 14 between the two partitions 13. The bay lamp 10 of the present invention further comprises a light source module 3 and a transparent cover 8. The metal lampholder 1 has a heated surface 12, and the light source module 3 is fixed to the heated surface 12, and the metal lampholder 1 has two carrier brackets 16 extended from both sides of the corresponding heated surface 12, and the two carrier brackets 16 jointly have an engagement portion 161 disposed on corresponding internal sides, and both sides of the transparent cover 8 are engaged with the corresponding engagement portion 161, such that the transparent cover 8 is covered onto the light source module 3 to simplify the assembling process of the bay lamp 10.

In summation of the description above, the present invention achieves the expected objectives and overcomes the drawbacks of the related art, and the invention complies with patent application requirements, and is thud duly filed for patent application.

While the invention has been described by means of specific embodiments, numerous modifications and variations could be made thereto by those skilled in the art without departing from the scope and spirit of the invention set forth in the claims.

What is claimed is:

1. A bay lamp with a cooling plate, comprising:
a metal lampholder; and
at least one cooling plate, including a vertical plate extended from the metal lampholder, a transverse plate bent and extended from the vertical plate, and a spacing formed between the transverse plate and the metal lampholder.

2. The bay lamp with a cooling plate according to claim 1, wherein the transverse plate is extended outwardly towards the exterior of the metal lampholder.

3. The bay lamp with a cooling plate according to claim 1, wherein the vertical plate and the metal lampholder are perpendicular to each other, and the transverse plate has an inclined section and a horizontal section extended from the inclined section, and the inclined section is inclined with respect to the vertical plate, and the horizontal section is parallel to the metal lampholder.

4. The bay lamp with a cooling plate according to claim 1, further comprising a cover plate and a power supply, and the metal lampholder having two partitions extended from the metal lampholder and an accommodating space formed between the two partitions, and the two partitions separating the cooling plate from the accommodating space, and the cover plate covering the corresponding accommodating space, and the power supply being fixed to the cover plate and contained in the accommodating space.

5. The bay lamp with a cooling plate according to claim 4, further comprising an insulating element installed at the internal periphery of the insulating element.

6. The bay lamp with a cooling plate according to claim 5, wherein the metal lampholder has a bottom surface formed at the bottom of the accommodating space, and the insulating element is fixed onto the bottom surface.

7. The bay lamp with a cooling plate according to claim 5, wherein the insulating element is fixed onto a side of each partition adjacent to the accommodating space.

8. The bay lamp with a cooling plate according to claim 4, wherein the cooling plate comes with a quantity of two, and the metal lampholder has a heat dissipating surface formed on a side of the metal lampholder, and the two partitions and the two cooling plates are formed and extended from the heat dissipating surface, and installed on both sides of the two partitions respectively.

9. The bay lamp with a cooling plate according to claim 8, further comprising a light source module, and the metal lampholder having a heated surface opposite to the heat dissipating surface, and the light source module being fixed onto the heated surface.

10. The bay lamp with a cooling plate according to claim 9, further comprising a transparent cover, and the metal lampholder having two carrier brackets extended from two sides opposite to the heated surface, and the two carrier brackets jointly having an engagement portion disposed on corresponding internal sides of the two carrier brackets, and both sides of the transparent cover being engaged with the corresponding engagement portion, such that the transparent cover is covered onto the light source module.

11. The bay lamp with a cooling plate according to claim 4, further comprising two panels fixed to the metal lampholder and covered onto both ends of the two partitions respectively, and each panel having a main body and a fixed section perpendicularly extended from the main body and towards a direction approaching the partition, and both ends of the cover plate being fixed to the two fixed sections respectively.

12. The bay lamp with a cooling plate according to claim 11, wherein each main body has a plurality of vent holes.
